(19) United States
(12) Patent Application Publication
(10) Pub. No.: US 2009/0186735 A1
(43) Pub. Date: Jul. 23, 2009

(54) Hybrid drive unit

(75) Inventors: Makoto Iwanaka, Anjo (JP); Shigeki Takami, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/076,734

(22) Filed: Mar. 21, 2008

(30) Foreign Application Priority Data
Sep. 12, 2007 (JP) 2007-237123

(51) Int. Cl. F16H 3/64

(52) U.S. Cl. 475/5; 903/911

(57) ABSTRACT

A hybrid drive unit includes an input member connected to an engine; an output member connected to wheels; a rotary electric machine; and a pair of planetary gear units that each have at least three rotation elements. The hybrid drive unit is capable of realizing a plurality of shift speeds, one planetary gear unit of the pair of planetary gear units comprises at least one fixed rotation element that serves as a rotation element whose rotation is stopped by a non-rotating member, the one planetary gear unit serving as a decelerating planetary gear unit that decelerates a rotation of the rotary electric machine and transmits a decelerated rotation to the output member at all of the shift speeds, and the other planetary gear unit of the pair of planetary gear units serves as a shifting planetary gear unit that transmits a rotation of the input member to the output member.

### INCORPORATION BY REFERENCE

The disclosure of Japanese Patent Application No. 2007-237123 filed on Sep. 12, 2007 including the specification, drawings and abstract is incorporated herein by reference in its entirety.

### BACKGROUND

The present invention relates to a hybrid drive unit.

There exists a hybrid drive unit in Japanese Patent Application Publication Nos. JP-A-1998-339182 and JP-A-2006-183760, for example.

Japanese Patent Application Publication No. JP-A-1998-339182 discloses a hybrid drive unit with a continuously variable transmission (CVT) connected to an internal combustion engine for driving a vehicle with driving wheels driven through a final reduction gear unit. In the hybrid drive unit described in this document, the transmission includes a lock-up clutch and a first electric motor (corresponding to a rotary electric machine), which is capable of driving the driving wheels and is capable of energy regeneration by means of the driving wheels, that is connected to an intermediate shaft of the transmission. In addition, a clutch unit is interposed between accessories driven by the internal combustion engine and a crankshaft, and a second electric motor is provided to allow the accessories to be driven. Thus, when the vehicle is decelerated and is accompanied with a fuel cut-off, the second electric motor performs motoring of the internal combustion engine via the clutch unit to prevent the engine from stalling until the vehicle stops. Therefore, driving the vehicle and the accessories is made possible in an appropriate manner to various driving conditions.

In Japanese Patent Application Publication No. JP-A-1998-339182, because the first electric motor is directly connected immediately upstream of the final reduction gear unit, the first electric motor can be used for regeneration as well as for driving the vehicle as a motor, without requiring hydraulic pressure.

Japanese Patent Application Publication No. JP-A-2006-183760 discloses a hybrid motor vehicle having an internal combustion engine and a motor (an example of a rotary electric machine) used as power sources for driving the vehicle. The hybrid drive unit also includes a transmission for accelerating or decelerating the rotation of the internal combustion engine and the motor, in which the transmission employing a first Ravigneaux type planetary gear, and friction engagement elements that include a first brake, a second brake, and a first clutch, is a two input/one output type, and is capable of setting five or more different input rotational speeds with respect to one output rotational speed. With this technology, a required output power of the motor can be suppressed to a small level even if a required driving force increases, and thus a large displacement engine can be employed.

In Japanese Patent Application Publication No. JP-A-2006-183760, the rotation of the motor is decelerated through the planetary gear and transmitted to an output side. Because friction engagement elements need to operate in that decelerating state, hydraulic pressure is required in that decelerating state.

### SUMMARY

With Japanese Patent Application Publication No. JP-A-1998-339182, because the rotary electric machine is directly connected to an output member of the transmission (immediately upstream of a differential gear), a large torque is required of the rotary electric machine when it is intended to produce a larger driving force, resulting in an increase in the size of the rotary electric machine itself.

With Japanese Patent Application Publication No. JP-A-2006-183760, because the rotary electric machine is connected to an output shaft through the transmission portion including the hydraulically operated friction engagement elements (the clutch and the brakes), a high hydraulic pressure is required for the friction engagement when performing driving with the rotary electric machine or regeneration using the rotary electric machine.

In addition, in many cases, the rotary electric machine needs to be disposed in a position where a large diameter is impossible for installation reasons. In such a case, in order to ensure a certain degree of output power of the rotary electric machine, there occurs a necessity of choosing a rotary electric machine with a large overall length (with a rotor and a stator that are long in the direction of the rotating shaft), thus worsening the ease of installation.

The present invention thus includes a hybrid drive unit that can employ a comparatively small-sized rotary electric machine, and is also excellent with regard to ease of installation, without requiring a high hydraulic pressure for transmitting a driving force from the rotary electric machine to the output member.

According to an exemplary aspect of the invention, a hybrid drive unit includes an input member connected to an engine; an output member connected to wheels; a rotary electric machine; and a pair of planetary gear units that each have at least three rotation elements. The hybrid drive unit is capable of realizing a plurality of shift speeds, one planetary gear unit of the pair of planetary gear units comprises at least one fixed rotation element that serves as a rotation element whose rotation is stopped by a non-rotating member, the one planetary gear unit serving as a decelerating planetary gear unit that decelerates a rotation of the rotary electric machine and transmits a decelerated rotation to the output member at all of the shift speeds, and the other planetary gear unit of the pair of planetary gear units serves as a shifting planetary gear unit that transmits a rotation of the input member to the output member.

According to an exemplary aspect of the invention, a hybrid drive unit includes an input member connected to an engine; an output member connected to wheels; a single rotary electric machine; a decelerating planetary gear unit; and a shifting planetary gear unit. The decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine. The shifting planetary gear unit comprises a first rotation element, a second rotation element, and a third rotation element, with the first rotation element of the shifting planetary gear unit being selectively connected to a non-rotating member and also being selectively connected to the input member, the second rotation element of the shifting planetary gear unit being connected to the second rotation element of the decelerating planetary gear unit and also being connected to the output member, and the third rotation element of the shifting planetary gear unit being selectively connected to the third rotation element of the decelerating planetary gear unit and also being selectively connected to the input member.

According to an exemplary aspect of the invention, a hybrid drive unit includes an input member connected to an engine; an output member connected to wheels; a single rotary electric machine; a decelerating planetary gear unit; and a shifting planetary gear unit. The decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine. The shifting planetary gear unit comprises a first rotation element, a second rotation element, and a third rotation element, with the first rotation element of the shifting planetary gear unit being connected to the second rotation element of the decelerating planetary gear unit and also being connected to the output member, the second rotation element of the shifting planetary gear unit being selectively connected to the input member, and the third rotation element of the shifting planetary gear unit being selectively connected to the third rotation element of the decelerating planetary gear unit, the input member and to a non-rotating member.

According to an exemplary aspect of the invention, a hybrid drive unit includes an input member connected to an engine; an output member connected to wheels; a single rotary electric machine; a decelerating planetary gear unit; and a shifting planetary gear unit. The decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine. The shifting planetary gear unit comprises a first rotation element, a second rotation element, and a third rotation element, with the first rotation element of the shifting planetary gear unit being selectively connected to the second rotation element of the decelerating planetary gear unit and being selectively connected to the input member, the second rotation element of the shifting planetary gear unit being connected to the input member, and the third rotation element of the shifting planetary gear unit being selectively connected to the third rotation element of the decelerating planetary gear unit and being selectively connected to a non-rotating member.

### BRIEF DESCRIPTION OF THE DRAWINGS

Various exemplary aspects of the invention will be described with reference to the drawings, wherein

FIG. 1 is a skeleton diagram showing a hybrid drive unit according to a first embodiment of the present invention;

FIG. 2 is a view showing an operation table according to the first embodiment;

FIGS. 3A-3D show velocity diagrams according to the first embodiment;

FIG. 4 is a skeleton diagram showing a hybrid drive unit according to a second embodiment of the present invention;

FIG. 5 is a view showing an operation table according to the second embodiment;

FIGS. 6A-6D show velocity diagrams according to the second embodiment;

FIG. 7 is a skeleton diagram showing a hybrid drive unit according to a third embodiment of the present invention;

FIG. 8 is a skeleton diagram showing a hybrid drive unit according to a fourth embodiment of the present invention;

FIG. 9 is a view showing an operation table according to the fourth embodiment;

FIGS. 10A-10D show velocity diagrams according to the fourth embodiment;

FIG. 11 is a skeleton diagram showing a hybrid drive unit according to a fifth embodiment of the present invention;

FIG. 12 is a skeleton diagram showing a hybrid drive unit according to a sixth embodiment of the present invention;

FIG. 13 is a view showing an operation table according to the sixth embodiment;

FIGS. 14A-14D show velocity diagrams according to the sixth embodiment;

FIG. 15 is a skeleton diagram showing a hybrid drive unit according to a seventh embodiment of the present invention;

FIG. 16 is a view showing an operation table according to the seventh embodiment;

FIGS. 17A-17D show velocity diagrams according to the seventh embodiment; and

FIGS. 18A-18C show velocity diagrams according to the seventh embodiment.

### DETAILED DESCRIPTION OF EMBODIMENTS

### 1. First Embodiment

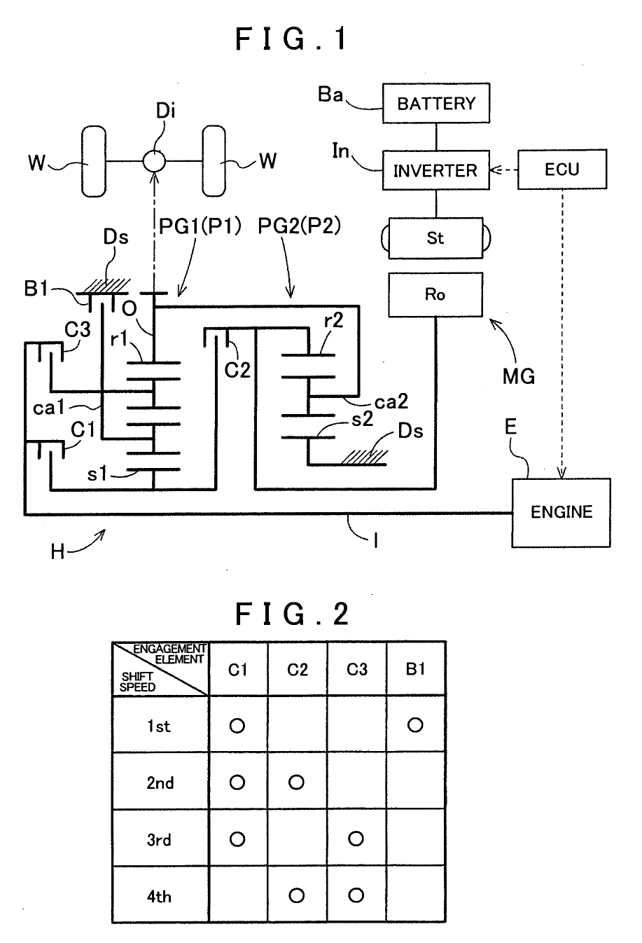

First, a first embodiment of the present invention will be described based on the drawings. FIG. 1 is a skeleton diagram showing a structure of a hybrid drive unit H of the present embodiment.

This hybrid drive unit H includes an input member (input shaft) I connected to an engine E, an output member (output gear) O connected to wheels W, a motor/generator MG, a first planetary gear mechanism PG1 constituting a shifting planetary gear unit P1, and a second planetary gear mechanism PG2 constituting a decelerating planetary gear unit P2. These devices are housed in a drive unit case Ds (hereinafter called simply “case Ds”) that is fixed to a vehicle body. Note that the motor/generator MG corresponds to a “rotary electric machine” of the present invention.

### 1-1. Structures of Various Portions of Hybrid Drive Unit H

The input member I is connected to the engine E. Here, various kinds of commonly known engines such as a gasoline engine and a diesel engine can be used as the engine E. The input member I is connected as a unit to an output rotating shaft, such as a crankshaft of the engine E, and is preferably structured to be connected to the output rotating shaft of the engine E with a damper or a clutch interposed therebetween. The output member O is connected to the wheels W so as to be able to transmit the rotational driving force through a differential device Di, and so on.

The present example employs a structure in which the input member I is disposed at an axial center in a radial direction of the hybrid drive unit H, and the output member O is arranged in a middle position between the front end (left side in FIG. 1) and the rear end (right side in FIG. 1), where the rotary electric machine MG and the engine E are disposed, of the hybrid drive unit H to provide an output toward an outside in a radial direction.

As shown in FIG. 1, the motor/generator MG has a stator St that is fixed to the case Ds, and a rotor Ro that is rotatably supported radially inside the stator St. The rotor Ro of the motor/generator MG is coupled to rotate as a unit with a ring gear r2 of the second planetary gear mechanism PG2. On the other hand, the motor/generator MG is electrically connected, through an inverter In, to a battery Ba serving as an electric storage device, and is able to serve as a motor (electric motor) that is supplied with electric power and generates motive power, and as a generator (electricity generating machine) that is supplied with motive power and generates electric power.

The motor/generator MG mainly serves as a motor that supplements a driving force for vehicle running, but also serves as a generator during regenerative braking for decelerating the vehicle, and so on. Operation of the motor/generator MG is performed according to control commands from a control unit ECU via the inverter In. The control unit ECU also controls an operating state of the engine E and engagement/disengagement states of friction engagement elements (first, second, and third clutches C1, C2, C3, and brake B1) included in the hybrid drive unit H.

As shown in FIG. 1, the first planetary gear mechanism PG1 is a double-pinion type planetary gear mechanism that is arranged coaxially with the input member I. In other words, the first planetary gear mechanism PG1 has, as rotation elements, a carrier ca1 that supports a plurality of pairs of pinion gears, as well as a sun gear s1 and a ring gear r1 that respectively mesh with the pinion gears.

A structure is employed in which the sun gear s1 is selectively connected to the input member I by the first clutch C1 serving as a first friction engagement element, and also a structure is employed in which the sun gear s1 is selectively connected to the ring gear r2 of the second planetary gear mechanism PG2 by the second clutch C2 serving as a second friction engagement element. A structure is employed in which the carrier ca1 is selectively connected to the input member I by the third clutch C3 serving as a third friction engagement element, and also a structure is employed in which the carrier ca1 is selectively connected to the case Ds, which is a non-rotating member, by the brake B1 serving as a fourth friction engagement element, to be stopped from rotating (to be fixed). The ring gear r1 is connected to the output member O. The ring gear r1 also rotates as a unit together with a carrier ca2 of the second planetary gear mechanism PG2.

As a result, the first planetary gear mechanism PG1 mainly serves as the shifting planetary gear unit P1 that changes the rotation speed of the input member I and transmits the rotation to the output member O.

The second planetary gear mechanism PG2 is a single-pinion type planetary gear mechanism that is arranged coaxially with the input member I. In other words, the second planetary gear mechanism PG2 has, as rotation elements, the carrier ca2 that supports a plurality of pinion gears, as well as a sun gear s2 and the ring gear r2 that respectively mesh with the pinion gears. The ring gear r2 is connected to the rotor Ro of the rotary electric machine MG, and also selectively connected to the sun gear s1 of the first planetary gear mechanism PG1 by the second clutch C2 serving as a second friction engagement element. The carrier ca2 is connected to the output member O. Therefore, the carrier ca2 also rotates as a unit together with the ring gear r1 of the first planetary gear mechanism PG1. The sun gear s2 is connected to the case Ds serving as a non-rotating member, to be stopped from rotating.

As a result, the second planetary gear mechanism PG2 mainly serves as the decelerating planetary gear unit that decelerates the rotation speed of the motor/generator MG and transmits the rotation to the output member O.

### 1-2. Shift Speeds Realizable in Hybrid Drive Unit H

A hybrid drive unit H of the present application includes, as friction engagement elements, the first clutch C1, the second clutch C2, the third clutch C3, and the brake B1. Each of these friction engagement elements selectively connects one rotation element of each of the first planetary gear mechanism PG1 and the second planetary gear mechanism PG2 to another rotation element, or selectively fixes the one rotation element to the case Ds serving as a non-rotating member. As these friction engagement elements, multi-plate clutches and multi-plate brakes, both of which are hydraulically operated, can be used.

These friction engagement elements C1, C2, C3, and B1 are engaged and disengaged in accordance with supply and release of hydraulic pressure that is controlled by the control unit ECU, based on a prescribed shift map determined by a relation between a vehicle speed and a requested driving force, and thus a plurality of shift speeds are achieved. Moreover, in this case, the control unit ECU controls a rotation speed and a rotation torque of the motor/generator MG, and also controls a rotation speed and a rotation torque of the engine E.

FIG. 2 is an operation table showing the operating states of the plurality of the friction engagement elements C1, C2, C3, and B1 at each shift speed. In this figure, “∘” indicates that each of the friction engagement elements is in an engagement state. On the other hand, “no mark” indicates that each of the friction engagement elements is in a disengagement state.

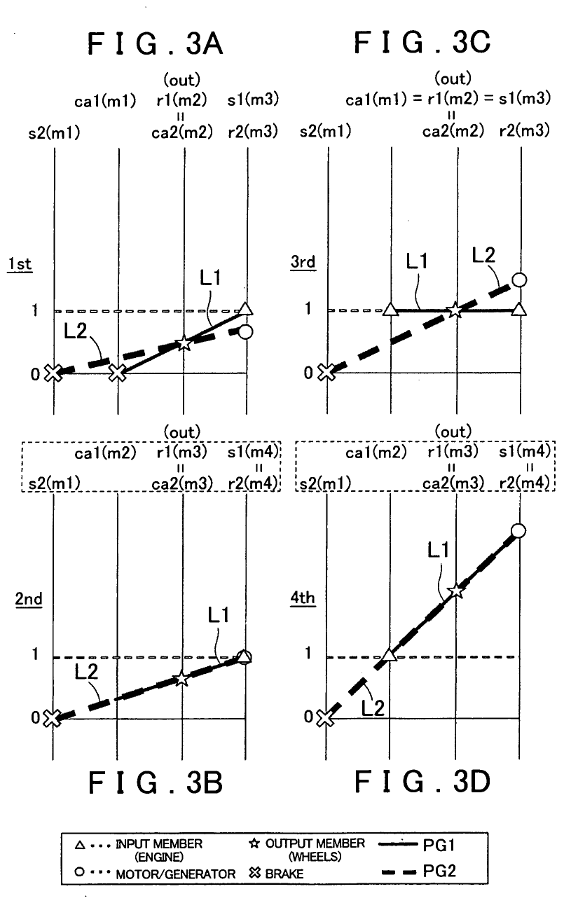

FIGS. 3A-3D show velocity diagrams of the first planetary gear mechanism PG1 and the second planetary gear mechanism PG2, in which FIGS. 3A-3D are velocity diagrams showing a first speed to a fourth speed, in the listed order. To explain the relationship with operation modes to be described later in detail, the first speed and the third speed are operation patterns in what is called “independent operation mode” in the present application, and the second speed and the fourth speed are operation patterns in what is called “unit operation mode” in the present application.

In these velocity diagrams, each vertical axis corresponds to the rotation speed of each rotation element. In other words, “0” that is written for the vertical axis indicates that the rotation speed is zero, and “1” indicates that the rotation speed is the same as the rotation speed of the input member I, representing that upside is positive and downside is negative. Besides, each of the parallel arranged multiple vertical lines corresponds to each rotation element of the first planetary gear mechanism PG1 and the second planetary gear mechanism PG2. In other words, “ca1,” “r1,” and “s1,” which are written at the top of the vertical lines, correspond to the carrier ca1, the ring gear r1, and the sun gear s1, respectively, of the first planetary gear mechanism PG1, and “s2,” “ca2,” and “r2” correspond to the sun gear s2, the carrier ca2, and the ring gear r2, respectively, of the second planetary gear mechanism PG2. Moreover, the spaces between the vertical lines corresponding to the rotation elements correspond to the gear ratios of the first planetary gear mechanism PG1 and the second planetary gear mechanism PG2. Furthermore, in FIGS. 3A and 3C, the straight line L1 indicates an operating state of the first planetary gear mechanism PG1, and the straight line L2 indicates an operating state of the second planetary gear mechanism PG2. Note that, at each of the second speed and the fourth speed shown in FIGS. 3B and 3D, the first planetary gear mechanism PG1 and the second planetary gear mechanism PG2 follow the same straight line on each velocity diagram. Therefore, each line of these overlapping straight lines L1 and L2 indicates an operating condition in which the first planetary gear mechanism PG1 and the second planetary gear mechanism PG2 operate as a unit with each other at each shift speed. Note that, in these velocity diagrams, the symbols, white circle, white triangle, white star, and white cross indicate a rotation speed of the motor/generator MG, a rotation speed of the input member I (engine E), a rotation speed of the output member O, and that the rotation is stopped by connection to the brake B1 or to the case Ds, respectively.

In FIGS. 2 and 3, “1st,” “2nd,” “3rd,” and “4th” indicate the first speed, the second speed, the third speed, and the fourth speed, respectively.

As described above, in a hybrid drive unit H of the present application, the “independent operation mode,” in which the first planetary gear mechanism PG1 and the second planetary gear mechanism PG2 operate independently, and the “unit operation mode,” in which both the first and second planetary gear mechanisms PG1 and PG2 operate as a unit with each other, are achieved according to an engagement/disengagement state of the plurally provided friction engagement elements.

The relations of the rotation elements constituting the planetary gear mechanisms PG1 and PG2, and speed changing states will be described below, in the “independent operation mode” and “unit operation mode” mentioned above.

Independent Operation Mode

In the independent operation mode, the second clutch C2 is disengaged, and thus the rotation of the input member I and the rotation of the rotary electric machine MG are transmitted through the first planetary gear mechanism PG1 and the second planetary gear mechanism PG2 to the output member O, independently from each other. In this operation mode, the relations of the rotation elements of each mechanism of the planetary gear mechanisms PG1 and PG2 are as follows.

First Planetary Gear Mechanism PG1

In the first planetary gear mechanism PG1, the carrier ca1, the ring gear r1, and the sun gear s1 respectively serve as, in the order of rotation speed, a “first rotation element (m1),” “second rotation element (m2),” and “third rotation element (m3)” of the shifting planetary gear unit P1.

Second Planetary Gear Mechanism PG2

In the second planetary gear mechanism PG2, the sun gear s2, the carrier ca2, and the ring gear r2 respectively serve as, in the order of rotation speed, a “first rotation element (m1),” “second rotation element (m2),” and “third rotation element (m3)” of the decelerating planetary gear unit P2.

Unit Operation Mode

In the unit operation mode, with the second clutch C2 engaged, the first planetary gear mechanism PG1 and the second planetary gear mechanism PG2 constitute one speed change mechanism and operate as a unit with each other, and thus the rotation of the input member I and the rotation of the rotary electric machine MG are changed in speed and transmitted to the output member O.

In this operation mode, each rotation element of the planetary gear mechanisms PG1 and PG2, when the mechanisms are assumed as the one speed change mechanism, serves as follows: the sun gear s2 of the second planetary gear mechanism PG2 as “first rotation element (m1),” the carrier ca1 of the first planetary gear mechanism PG1 as “second rotation element (m2),” the ring gear r1 of the first planetary gear mechanism PG1 and the carrier ca2 of the second planetary gear mechanism PG2 as “third rotation element (m3),” and the sun gear s1 of the first planetary gear mechanism PG1 and the ring gear r2 of the second planetary gear mechanism PG2 as “fourth rotation element (m4).”

Such a speed change mechanism formed in the unit operation mode is shown in a block enclosed by a dashed line.

In addition, in a hybrid drive unit H of the present application, by disengaging an appropriate friction engagement element, the input member I (engine E) can be disconnected from the rotary electric machine MG. In the present first embodiment, the above-mentioned disconnection can be achieved by completing disengagement of the first clutch C1 serving as the first friction engagement element and the third clutch C3 serving as the third friction engagement element.

### Shift Speeds

In the above-described structure, each shift speed is realized as follows.

First Speed (1st)

As shown in FIG. 2, at the first speed (1st), only the first clutch C1 and the brake B1 are engaged. Then, as a result of engaging the brake, the first rotation element ca1 of the first planetary gear mechanism PG1 is fixed, and thus the rotation of the input member I is provided as an input to the third rotation element s1. In this state, as indicated by the straight line L1 in FIG. 3A, the rotation of the input member I is decelerated and transmitted to the ring gear r1 serving as the second rotation element of the first planetary gear mechanism PG1.

On the other hand, as to the motor/generator MG, in the second planetary gear mechanism PG2, as indicated by the straight line L2 in FIG. 3A, the first rotation element s2 of the second planetary gear mechanism PG2 is fixed, and the rotation of the motor/generator MG is provided as an input to the third rotation element r2. In this state, the rotation of the motor/generator MG is decelerated and transmitted to the carrier ca2 serving as the second rotation element of the second planetary gear mechanism PG2, and is provided as an output from the output member O. Among the plurality of shift speeds, the first speed is set to have the largest speed ratio.

Second Speed (2nd)

As shown in FIG. 2, at the second speed (2nd), only the first clutch C1 and the second clutch C2 are engaged. Then, as a result of engaging the second clutch C2, the first planetary gear mechanism PG1 and the second planetary gear mechanism PG2 operate as a unit with each other. Because both the first clutch C1 and the second clutch C2 are engaged at this shift speed, the rotation speed of the input member I and the rotation speed of the motor/generator MG are the same as each other. Then, as indicated by the partly overlapping straight lines L1 and L2 in FIG. 3B, because the sun gear s2 of the second planetary gear mechanism PG2, which serves as the first rotation element in the speed change mechanism formed as an integrated unit of the first planetary gear mechanism PG1 and the second planetary gear mechanism PG2, is fixed, the rotation of the engine E and the rotation of the motor/generator MG are decelerated by the speed change mechanism, then transmitted to the ring gear r1 of the first planetary gear mechanism PG1 (which rotates as a unit together with the carrier ca2 of the second planetary gear mechanism PG2), which serves both as the third rotation element and as an output rotation element of the speed change mechanism, and then provided as an output.

Among the plurality of shift speeds, the second speed is set to have a comparatively large speed ratio.

Third Speed (3rd)

As shown in FIG. 2, at the third speed (3rd), only the first clutch C1 and the third clutch C3 are engaged. Then, as a result of engaging both the first clutch C1 and the third clutch C3, differential operation of the first planetary gear mechanism PG1 is limited. Therefore, in this state, as shown by the straight line L1 in FIG. 3C, the rotation of the input member I is transmitted to the ring gear r1 serving as the second rotation element of the first planetary gear mechanism PG1, without change.

On the other hand, as to the motor/generator MG, in the second planetary gear mechanism PG2, as indicated by the straight line L2 in FIG. 3C, the first rotation element s2 of the second planetary gear mechanism PG2 is fixed, and the rotation of the motor/generator MG is provided as an input to the third rotation element r2. In this state, the rotation of the motor/generator MG is decelerated and transmitted to the carrier ca2 serving as the second rotation element of the second planetary gear mechanism PG2. The rotation speed of the carrier ca2 is made equal to the rotation speed of the engine E that is provided as an input through the input member I, and the rotation is output at that speed from the output member O. Although the third speed is a shift speed at which the engine rotation is output without shifting, the rotation of the motor/generator MG is decelerated in the same manner as described so far.

Fourth Speed (4th)

As shown in FIG. 2, at the fourth speed (4th), only the second clutch C2 and the third clutch C3 are engaged. Then, as a result of engaging the second clutch C2, the first planetary gear mechanism PG1 and the second planetary gear mechanism PG2 operate as a unit with each other. Because the third clutch C3 is engaged at this shift speed, the rotation of the input member I is provided as an input to the carrier ca1 of the first planetary gear mechanism PG1. Then, as indicated by the partly overlapping straight lines L1 and L2 in FIG. 3D, because the sun gear s2 of the second planetary gear mechanism PG2, which serves as the first rotation element in the speed change mechanism formed as an integrated unit of the first planetary gear mechanism PG1 and the second planetary gear mechanism PG2, is fixed, the rotation of the input member I is accelerated while the rotation of the motor/generator MG is decelerated, and then, the rotation of both is transmitted to the ring gear r1 of the first planetary gear mechanism PG1 (which rotates as a unit together with the carrier ca2 of the second planetary gear mechanism PG2), which serves both as the third rotation element and as an output rotation element of the speed change mechanism, and then provided as an output.

Therefore, at this shift speed; there can be realized a so-called overdrive state in which the rotation speed of the engine E is accelerated and transmitted to the output member O.

Other embodiments of the present application will be described below. The description of the other embodiments will be made using skeleton diagrams, operation tables, and velocity diagrams, in the same formats as those described with respect to FIGS. 1, 2, and 3A to 3D.

In addition, in any one of the other embodiments, the hybrid drive unit H has the shifting planetary gear unit P1 and the decelerating planetary gear unit P2, in which the shifting planetary gear unit P1 mainly changes the speed of the rotation provided as an input from the engine E through the input member I, and transmits the rotation to the output member O, and in which the decelerating planetary gear unit P2 mainly decelerates the rotation of the motor/generator MG, and transmits the rotation to the output member O. Furthermore, any one of the examples is structured so as to be able to realize the “independent operation mode,” in which the shifting planetary gear unit P1 and the decelerating planetary gear unit P2 operate independently, and “unit operation mode,” in which they operate as a unit, and also to be able to realize individual shift speeds by switching the mode.

In the above-described structure, the rotation of the motor/generator MG is decelerated and transmitted to the downstream side of the power transmission at every shift speed.

In each embodiment, description will be given with respect to distinction of a planetary gear mechanism PG employed as the shifting planetary gear unit P1 and that employed as the decelerating planetary gear unit P2, with respect to connecting relations of the rotation elements (m1 to m4) in each planetary gear mechanism PG, with respect to connecting relations with the friction engagement elements (C1 to C4, B1, and B2), and with respect to operating states at shift speeds realized.

### 2. Second Embodiment

Next, a second embodiment of the present invention will be described.

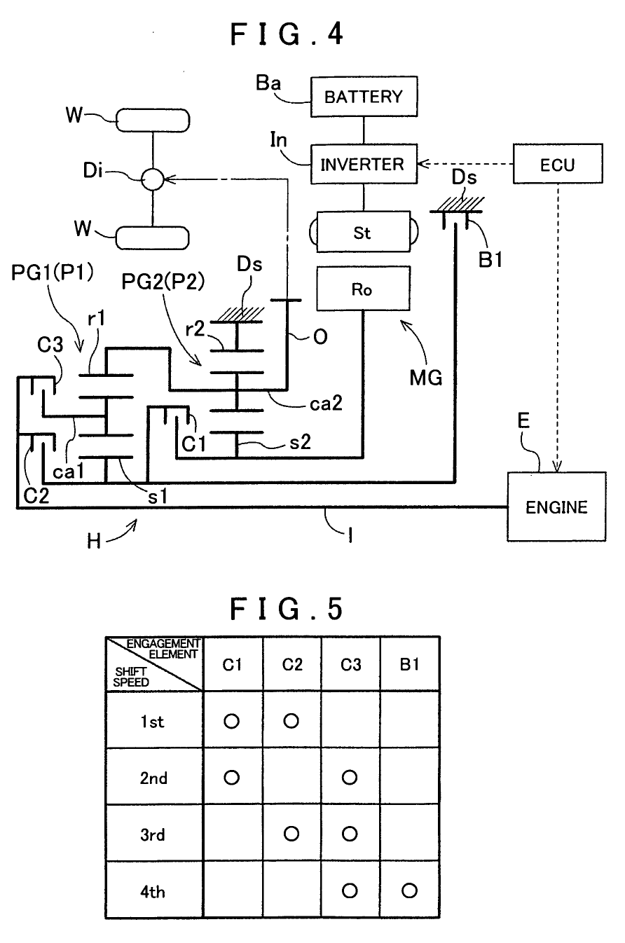

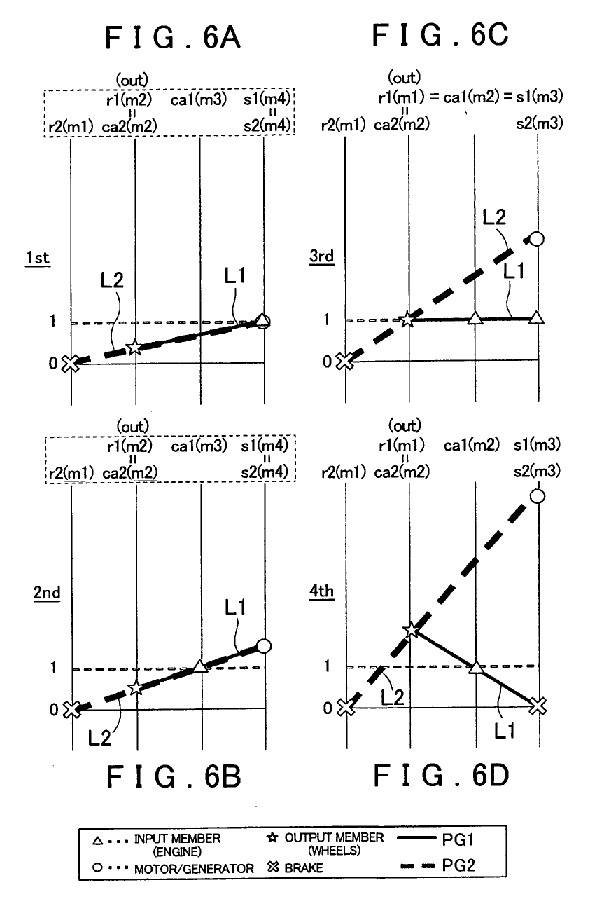

FIG. 4 is a skeleton diagram showing a structure of a hybrid drive unit H according to the present embodiment, FIG. 5 is an operation table of friction engagement elements included in the hybrid drive unit H according to the present embodiment, and each of FIGS. 6A to 6D is a velocity diagram at each shift speed.

In the present example, as shown in FIG. 4, a first planetary gear mechanism PG1 is a single-pinion type planetary gear mechanism that is arranged coaxially with an input member I.

A structure is employed in which a sun gear s1 is selectively connected to a sun gear s2 of a second planetary gear mechanism PG2 by a first clutch C1 serving as a first friction engagement element, and also selectively connected to the input member I by a second clutch C2 serving as a second friction engagement element. The sun gear s1 is also selectively connected to a case Ds, which is a non-rotating member, by a brake B1 serving as a fourth friction engagement element, to be stopped from rotating. A carrier ca1 is selectively connected to the input member I by a third clutch C3 serving as a third friction engagement element. A ring gear r1 is connected to a carrier ca2 of the second planetary gear mechanism PG2, and then connected to an output member O.

As a result, the first planetary gear mechanism PG1 mainly serves as a shifting planetary gear unit P1 that changes the rotation speed of the input member I and transmits the rotation to the output member O.

The second planetary gear mechanism PG2 is a single-pinion type planetary gear mechanism that is arranged coaxially with the input member I.

The sun gear s2 is connected to a rotor Ro of a rotary electric machine MG, and also selectively connected to the sun gear s1 of the first planetary gear mechanism PG1 by the first clutch C1 serving as the first friction engagement element. The carrier ca2 is connected to the output member O, and also connected to the ring gear r1 of the first planetary gear mechanism PG1. A ring gear r2 is connected to the case Ds, which is a non-rotating member, to be stopped from rotating.

As a result, the second planetary gear mechanism PG2 mainly serves as a decelerating planetary gear unit P2 that always decelerates the rotation of the motor/generator MG and transmits the rotation to the output member O.

In the present example, the first clutch C1, which is the first friction engagement element, serves to unite the shifting planetary gear unit P1 with the decelerating planetary gear unit P2. In other words, engaging the first clutch C1 makes both of the planetary gear units P1 and P2 unite with each other, whereas disengaging the first clutch C1 makes both of the planetary gear units P1 and P2 operate independently from each other.

### Shift Speeds

In the above-described structure, each shift speed is realized as follows.

First Speed (1st)

As shown in FIG. 5, at the first speed (1st), only the first clutch C1 and the second clutch C2 are engaged. Then, the first planetary gear mechanism PG1 and the second planetary gear mechanism PG2 unite with each other as a result of engaging the first clutch C1, and also, as a result of engaging the second clutch C2, the rotation of the input member I is provided as an input to the sun gears s1 and s2 of both the first and second planetary gear mechanisms PG1 and PG2, with the rotation of the motor/generator MG additionally provided as an input to the sun gears s1 and s2. Then, as indicated by the overlapping straight lines L1 and L2 in FIG. 6A, because the ring gear r2 of the second planetary gear mechanism PG2 is fixed, the rotation of the input member I and the rotation of the motor/generator MG are decelerated and transmitted to the carrier ca2 (connected to the ring gear r1 of the first planetary gear mechanism PG1), which is an output rotation element, of the second planetary gear mechanism PG2, to be provided as an output.

Second Speed (2nd)

As shown in FIG. 5, at the second speed (2nd), only the first clutch C1 and the third clutch C3 are engaged. Then, as a result of engaging the first clutch C1, the sun gear s1 of the first planetary gear mechanism PG1 is connected with the sun gear s2 of the second planetary gear mechanism PG2, and to these rotation elements, the rotation of the motor/generator MG is transmitted. On the other hand, as a result of engaging the third clutch C3, the rotation of the input member I is transmitted to the carrier ca1 of the first planetary gear mechanism PG1. Then, as indicated by the overlapping straight lines L1 and L2 in FIG. 6B, because the ring gear r2 of the second planetary gear mechanism PG2 is fixed, the rotation of the rotary electric machine MG and the rotation of the input member I are decelerated and transmitted to the carrier ca2 (connected to the ring gear r1 of the first planetary gear mechanism PG1), which is an output rotation element, of the second planetary gear mechanism PG2, to be provided as an output.

Third Speed (3rd)

As shown in FIG. 5, at the third speed (3rd), only the second clutch C2 and the third clutch C3 are engaged. Then, as a result of engaging both the clutches C2 and C3, a differential operation of the first planetary gear mechanism PG1 is limited, as indicated by the straight line L1 in FIG. 6C. Therefore, the ring gear r1 of the first planetary gear mechanism PG1 rotates at the same speed as the rotation speed of the input member I.

On the other hand, as to the motor/generator MG, in the second planetary gear mechanism PG2, as indicated by the straight line L2 in FIG. 6C, the ring gear r2 of the second planetary gear mechanism PG2 is fixed, and the rotation of the motor/generator MG is provided as an input to the sun gear s2. In this state, the rotation of the motor/generator MG is decelerated and transmitted to the carrier ca2 serving as the second rotation element of the second planetary gear mechanism PG2. The rotation speed of the carrier ca2 is made equal to the rotation speed of an engine E that is provided as an input through the input member I, and the transmitted rotation is output at that speed from the output member O. Although the third speed is a shift speed at which the engine rotation is output without shifting, the rotation of the motor/generator MG is decelerated in the same manner as described so far.

Fourth Speed (4th)

As shown in FIG. 5, at the fourth speed (4th), only the third clutch C3 and the brake B1 are engaged. Then, in a state that the sun gear s1 of the first planetary gear mechanism PG1 is fixed by the brake B1, the rotation of the input member I is transmitted through the third clutch C3 to the carrier ca1. As a result, the rotation of the engine is accelerated and transmitted to the ring gear r1, as indicated by the straight line L1 in FIG. 6D.

On the other hand, as to the motor/generator MG, in the second planetary gear mechanism PG2, as indicated by the straight line L2 in FIG. 6D, the first rotation element r2 of the second planetary gear mechanism PG2 is fixed, and the rotation of the motor/generator MG is provided as an input to the third rotation element s2. In this state, the rotation of the motor/generator MG is decelerated and transmitted to the carrier ca2 serving as the second rotation element of the second planetary gear mechanism PG2. The rotation of the carrier ca2 has an accelerated speed relative to the engine rotation, and is output from the output member O. At the fourth speed, the rotation of the input member I is accelerated and output, whereas the rotation of the motor/generator MG is decelerated in the same manner as described so far.

Therefore, at this shift speed, there can be realized a so-called overdrive state in which the rotation speed of the engine E is accelerated and transmitted to the output member O.

### 3. Third Embodiment

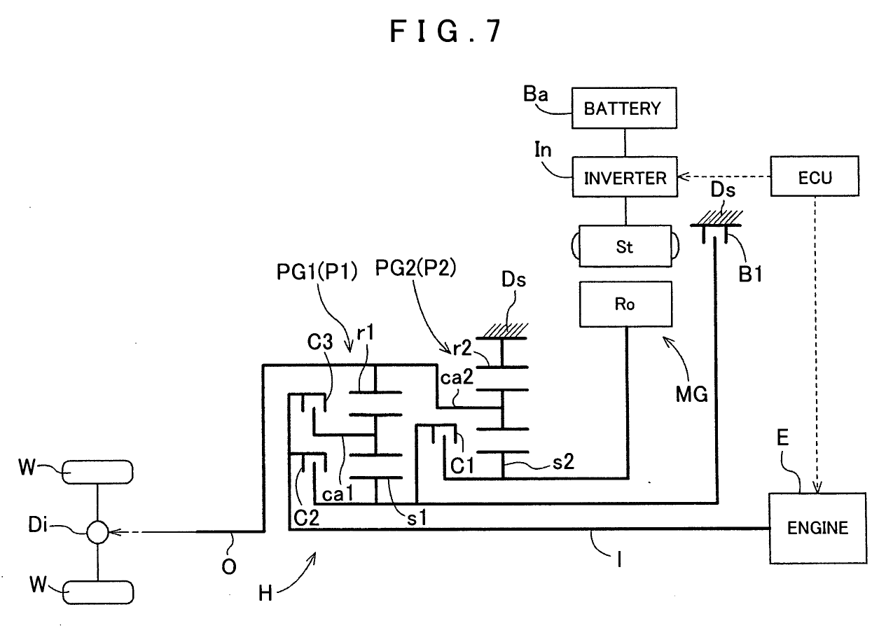

FIG. 7 is a skeleton diagram showing a structure of a hybrid drive unit H according to a present embodiment. As is evident from the comparison with the skeleton diagram showing the second embodiment in FIG. 4, in the present embodiment, an output member O connected to a ring gear r1 of a first planetary gear mechanism PG1 and to a carrier ca2 of a second planetary gear mechanism PG2 is extended toward the front side of the hybrid drive unit H (left side in FIG. 7), whereas in the second embodiment, an output is taken in a radial direction of the shaft of the hybrid drive unit H (toward an outside in a radial direction of the input shaft that is the input member I).

Therefore, in this hybrid drive unit H, an output after shifting can be obtained on the front side of the unit (on the side opposite the position where an engine E is disposed), and thus the present embodiment can be preferably adopted to a front-engine rear-drive vehicle.

The combinations of engagement and disengagement of the friction engagement elements to form each shift speed are the same as those previously described with respect to FIG. 5, and each velocity diagram of a speed changing state realized at each shift speed is as shown in FIGS. 6A-6D, which has been described in the second embodiment.

### 4. Fourth Embodiment

Next, a fourth embodiment of the present invention will be described.

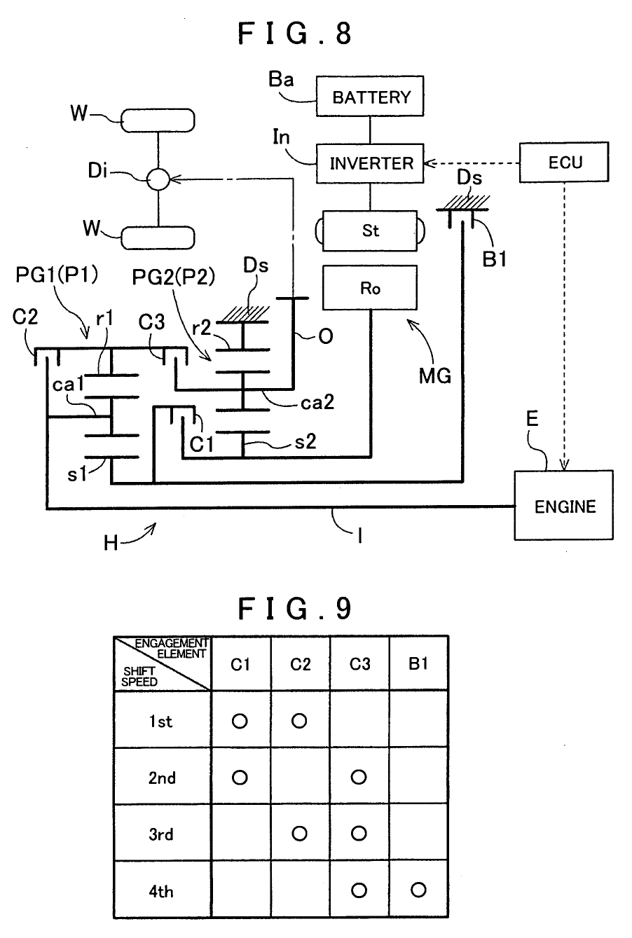

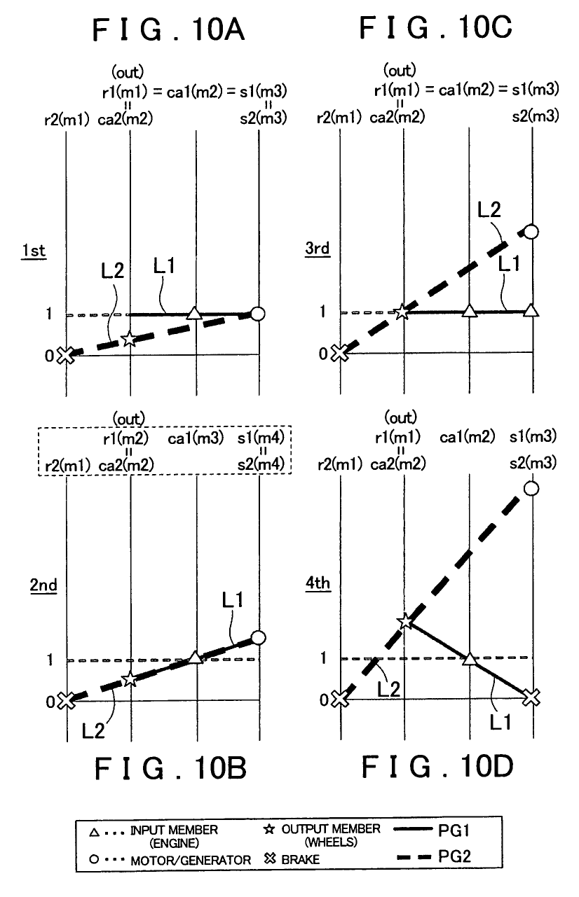

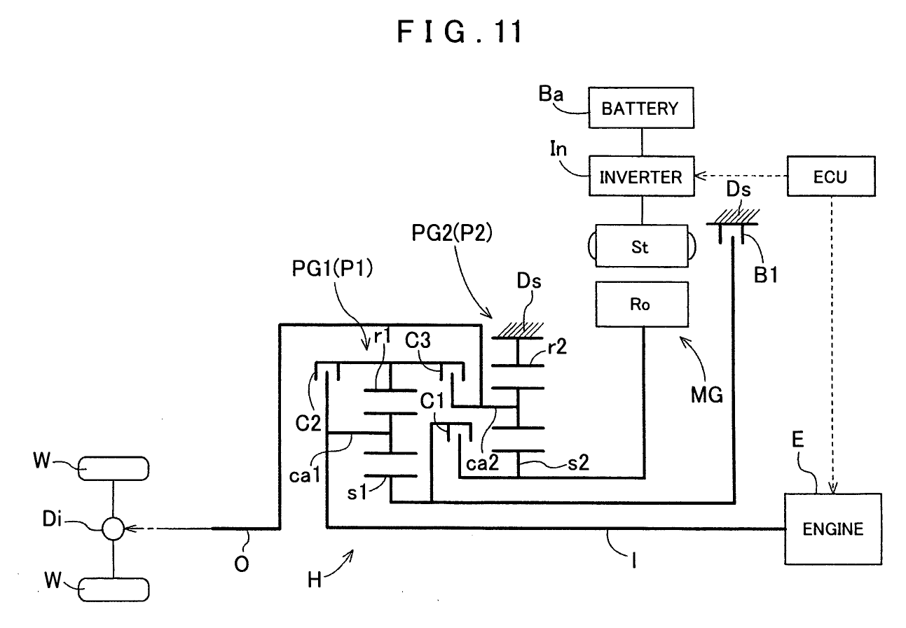

FIG. 8 is a skeleton diagram showing a structure of a hybrid drive unit H according to the present embodiment, FIG. 9 is an operation table of friction engagement elements included in the hybrid drive unit H according to the present embodiment, and each diagram in FIGS. 10A-10D is a velocity diagram at each shift speed.

In the present example, as shown in FIG. 8, a first planetary gear mechanism PG1 is a single-pinion type planetary gear mechanism that is arranged coaxially with an input member I.

A structure is employed in which a sun gear s1 is selectively connected to a case Ds, which is a non-rotating member, by a brake B1 serving as a fourth friction engagement element. The sun gear s1 is also selectively connected to a sun gear s2 of a second planetary gear mechanism PG2 by a clutch C1 serving as a first friction engagement element. A carrier ca1 is connected to the input member I. A ring gear r1 is selectively connected to the input member I by a second clutch C2 serving as a second friction engagement element, and also selectively connected to a carrier ca2 of the second planetary gear mechanism PG2 and to an output member O by a third clutch C3 serving as a third friction engagement element.

As a result, the first planetary gear mechanism PG1 mainly serves as a shifting planetary gear unit P1 that changes the rotation speed of the input member I and transmits the rotation to the output member O.

The second planetary gear mechanism PG2 is a single-pinion type planetary gear mechanism that is arranged coaxially with the input member I.

A ring gear r2 is connected to the case Ds, which is a non-rotating member, to be stopped from rotating. The carrier ca2 is connected to the output member O, and also selectively connected to the ring gear r1 of the first planetary gear mechanism PG1 by the third clutch C3 serving as the third friction engagement element. The sun gear s2 is connected to a rotor Ro of a rotary electric machine MG, and also selectively connected to the sun gear s1 of the first planetary gear mechanism PG1 by the first clutch C1 serving as the first friction engagement element.

As a result, the second planetary gear mechanism PG2 mainly serves as a decelerating planetary gear unit that always decelerates the rotation of the motor/generator MG and transmits the rotation to the output member O.

In the present example, both the first clutch C1, which is the first friction engagement element, and the third clutch C3, which is the third friction engagement element, serve to unite the shifting planetary gear unit P1 with the decelerating planetary gear unit P2. In other words, engaging both of the clutches C1 and C3 makes both of the planetary gear units P1 and P2 unite with each other.

### Shift Speeds

In the above-described structure, each shift speed is realized as follows.

First Speed (1st)

As shown in FIG. 9, at the first speed (1st), only the first clutch C1 and the second clutch C2 are engaged. Then, as a result of engaging the second clutch C2, the whole of the first planetary gear mechanism PG1 is fixed, as indicated by the straight line L1 in FIG. 10A. In other words, the sun gear s1, the carrier ca1 and the ring gear r1 rotate at the same speed as the rotation speed of the input member I. On the other hand, as a result of engaging the first clutch C1, the sun gear s1 of the first planetary gear mechanism PG1 and the sun gear s2 of the second planetary gear mechanism PG2 rotate at the rotation speed of the input member I, and the motor/generator MG also rotates at this speed. Therefore, the sun gear s2 of the second planetary gear mechanism PG2 rotates at the same speed as the engine rotation speed.

Then, as indicated by the straight line L2 in FIG. 10A, because the ring gear r2 in the second planetary gear mechanism PG2 is fixed, the rotation of the input member I and the rotation of the motor/generator MG are decelerated and transmitted to the carrier ca2, which is an output rotation element, of the second planetary gear mechanism PG2, to be provided as an output.

Second Speed (2nd)

As shown in FIG. 9, at the second speed (2nd), only the first clutch C1 and the third clutch C3 are engaged. Then, as a result of engaging the first clutch C1, the sun gear s1 of the first planetary gear mechanism PG1 is connected with the sun gear s2 of the second planetary gear mechanism PG2, and to these rotation elements, the rotation of the motor/generator MG is transmitted. On the other hand, as a result of engaging the third clutch C3, the ring gear r1 of the first planetary gear mechanism PG1 and the carrier ca2 of the second planetary gear mechanism PG2 are connected to each other. Therefore, the first planetary gear mechanism PG1 and the second planetary gear mechanism PG2 operate as a unit with each other, and, as indicated by the overlapping straight lines L1 and L2 in FIG. 10B, the rotation of the motor/generator MG and the rotation of the input member I are respectively decelerated and transmitted to the carrier ca2 (connected to the ring gear r1 of the first planetary gear mechanism PG1), which is an output rotation element, of the second planetary gear mechanism PG2, to be provided as an output.

Third Speed (3rd)

As shown in FIG. 9, at the third speed (3rd), only the second clutch C2 and the third clutch C3 are engaged. Then, as a result of engaging the second clutch C2, a differential operation of the first planetary gear mechanism PG1 is limited, as indicated by the straight line L1 in FIG. 10C. Therefore, the ring gear r1 and the sun gear s1 of the first planetary gear mechanism PG1 rotate at the same speed as the rotation speed of the input member I.

On the other hand, as to the motor/generator MG, in the second planetary gear mechanism PG2, because the first rotation element r2 of the second planetary gear mechanism PG2 is stopped from rotating, the rotation of the third rotation element s2, which is provided as an input from the motor/generator MG, is decelerated and transmitted to the carrier ca2, as indicated by the straight line L2 in FIG. 10C. Then, the transmitted rotation is output at that speed from the output member O. Although the third speed is a shift speed at which the engine rotation is output without shifting, the rotation of the motor/generator MG is decelerated in the same manner as described so far.

Fourth Speed (4th)

As shown in FIG. 9, at the fourth speed (4th), only the third clutch C3 and the brake B1 are engaged. Then, in a state that the sun gear s1 of the first planetary gear mechanism PG1 is fixed by the brake B1, the rotation of the input member I is transmitted to the carrier ca1, and the rotation of the engine is accelerated and transmitted to the ring gear r1, as indicated by the straight line L1 in FIG. 10D.

On the other hand, as to the motor/generator MG, in the second planetary gear mechanism PG2, as indicated by the straight line L2 in FIG. 10D, the ring gear r2 of the second planetary gear mechanism PG2 is fixed, and the rotation of the motor/generator MG is provided as an input to the sun gear s2. In this state, the rotation of the motor/generator MG is decelerated and transmitted to the carrier ca2 serving as the second rotation element of the second planetary gear mechanism PG2. The rotation of the carrier ca2 has an accelerated speed relative to the engine rotation, and is output from the output member O. Although the fourth speed is a shift speed at which the engine rotation is accelerated and provided as an output, the rotation of the motor/generator MG is decelerated in the same manner as described so far.

Therefore, at this shift speed, there can be realized a so-called overdrive state in which the rotation speed of an engine E is accelerated and transmitted to the output member O.

### 5. Fifth Embodiment

FIG. 11 is a skeleton diagram showing a structure of a hybrid drive unit H according to a present embodiment. As is evident from the comparison with the skeleton diagram showing the fourth embodiment in FIG. 8, in the present embodiment, an output member O connected to a carrier ca2 of a second planetary gear mechanism PG2 is extended toward the front side of the hybrid drive unit H (left side in FIG. 11), whereas in the fourth embodiment, an output is taken in a radial direction of the shaft of the hybrid drive unit H (toward an outside in a radial direction of the input shaft that is the input member I).

Therefore, in this hybrid drive unit H, an output after shifting can be obtained on the front side of the unit (on the side opposite the position where an engine E is disposed).

The combinations of engagement and disengagement of the friction engagement elements to form each shift speed are the same as those previously described with respect to FIG. 9, and each velocity diagram of a speed changing state realized at each shift speed is as shown in FIGS. 10A-10D, which has been described in the fourth embodiment.

### 6. Sixth Embodiment

Next, a sixth embodiment of the present invention will be described.

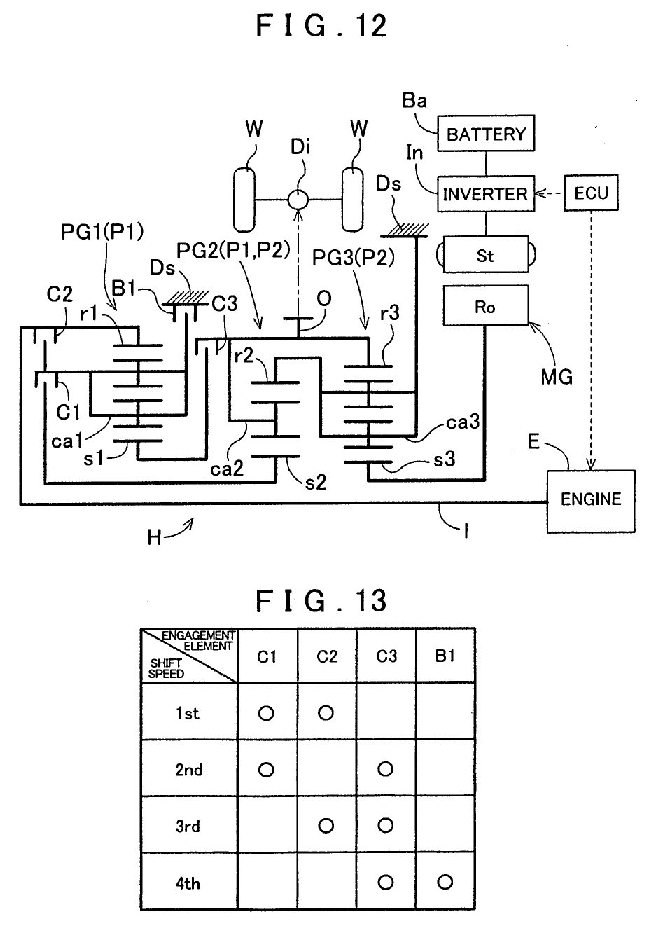

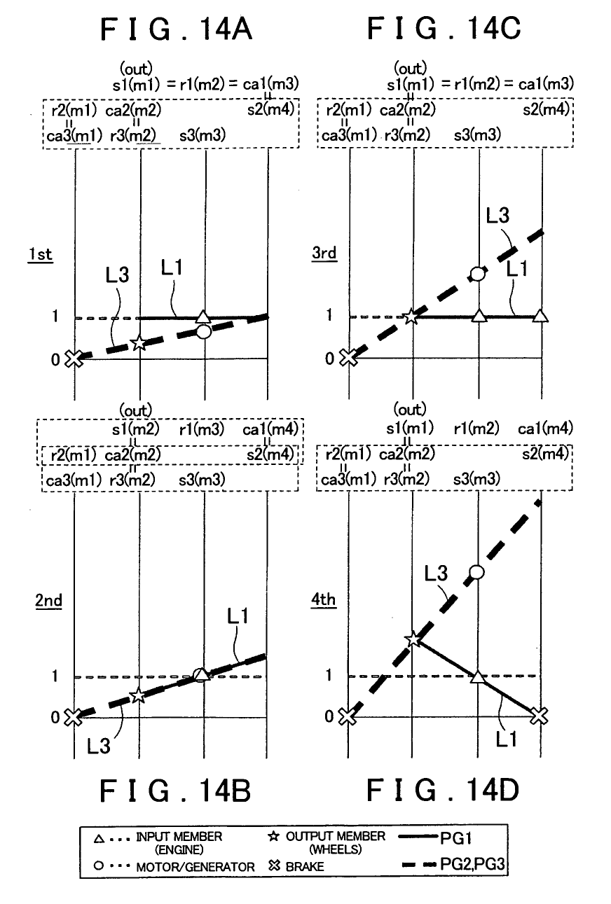

FIG. 12 is a skeleton diagram showing a structure of a hybrid drive unit H according to the present embodiment, FIG. 13 is an operation table of friction engagement elements included in the hybrid drive unit H according to the present embodiment, and each diagram in FIGS. 14A-14D is a velocity diagram at each shift speed.

In the present example, as shown in FIG. 12, a first planetary gear mechanism PG1 is a double-pinion type planetary gear mechanism that is arranged coaxially with an input member I.

A sun gear s1 is selectively connected to a carrier ca2 of a second planetary gear mechanism PG2 and to a ring gear r3 of a third planetary gear mechanism PG3 by a third clutch C3 serving as a third friction engagement element. Both of these rotation elements are connected to an output member O. A carrier ca1 is selectively connected to a sun gear s2 of the second planetary gear mechanism PG2 by a first clutch C1 serving as a first friction engagement element and to the input member I by a second clutch C2 serving as a second friction engagement element, and also is connected to a case Ds by a brake B1 serving as a fourth friction engagement element, to be stopped from rotating. A ring gear r1 is connected to the input member I, and selectively connected to the carrier ca1 by the second clutch C2 serving as the second friction engagement element.

As a result, the first planetary gear mechanism PG1 mainly serves as a shifting planetary gear unit P1 that changes the rotation speed of the input member I and transmits the rotation to the output member O.

The second planetary gear mechanism PG2 is a single-pinion type planetary gear mechanism that is arranged coaxially with the input member I.

The sun gear s2 is selectively connected to the carrier ca1 of the first planetary gear mechanism PG1 by the first clutch C1 serving as the first friction engagement element. The carrier ca2 is connected to the ring gear r3 of the third planetary gear mechanism PG3 and to the output member O, and also is selectively connected to the sun gear s1 of the first planetary gear mechanism PG1 by the third clutch C3 serving as the third friction engagement element. A ring gear r2 is connected to a carrier ca3 of the third planetary gear mechanism PG3, and this rotation element is connected to the case Ds, which is a non-rotating member, to be stopped from rotating.

The third planetary gear mechanism PG3 is a double-pinion type planetary gear mechanism that is arranged coaxially with the input member I.

A sun gear s3 is connected to a rotor Ro of a motor/generator MG. The carrier ca3 is connected to the ring gear r2 of the second planetary gear mechanism PG2, and is also connected to the case Ds, which is a non-rotating member, to be stopped from rotating. The ring gear r3 is connected to the output member O and to the carrier ca2 of the second planetary gear mechanism PG2, and also is selectively connected to the sun gear s1 of the first planetary gear mechanism PG1 by the third clutch C3 serving as the third friction engagement element.

As a result, both the second planetary gear mechanism PG2 and the third planetary gear mechanism PG3 mainly serve together as a decelerating planetary gear unit P2 that always decelerates the rotation of the motor/generator MG and transmits the rotation to the output member O.

In the present example, the third clutch C3, which is the third friction engagement element, serves to unite the shifting planetary gear unit P1 with the decelerating planetary gear unit P2.

### Shift Speeds

In the above-described structure, each shift speed is realized as follows.

First Speed (1st)

As shown in FIG. 13, at the first speed (1st), only the first clutch C1 and the second clutch C2 are engaged. Then, as a result of engaging the second clutch C2, the first planetary gear mechanism PG1 is fixed, as indicated by the straight line L1 in FIG. 14A. In other words, the sun gear s1, the carrier ca1, and the ring gear r1 rotate at the same speed as the rotation speed of the input member I. In addition, as a result of engaging the first clutch C1, the sun gear s2 of the second planetary gear mechanism PG2 rotates at the same speed as that of the input member I. On the other hand, the rotation of the motor/generator MG is provided as an input to the sun gear s3 of the third planetary gear mechanism PG3.

Then, as indicated as the straight line L3 in FIG. 14A, because the ring gear r2 of the second planetary gear mechanism PG2 and the carrier ca3 of the third planetary gear mechanism PG3 are fixed in a decelerating mechanism constituted by the second planetary gear mechanism PG2 and the third planetary gear mechanism PG3, the rotation of the input member I and the rotation of the motor/generator MG are decelerated and transmitted to the output member O, which is an output rotation element, to be provided as an output.

Second Speed (2nd)

As shown in FIG. 13, at the second speed (2nd), only the first clutch C1 and the third clutch C3 are engaged. Then, as a result of engaging the first clutch C1 and the third clutch C3, the first planetary gear mechanism PG1 and the second planetary gear mechanism PG2 unite with each other to form a speed change mechanism. Then, because the ring gear r2 of the second planetary gear mechanism PG2 is fixed in this speed change mechanism, the rotation of the input member I is decelerated and transmitted to the output member O, as indicated by the straight line L1 in FIG. 14B.

On the other hand, as to the motor/generator MG, because the decelerating mechanism is formed by both the second planetary gear mechanism PG2 and the third planetary gear mechanism PG3, and because the ring gear r2 of the second planetary gear mechanism PG2 and the carrier ca3 of the third planetary gear mechanism PG3 are fixed in the decelerating mechanism, the rotation of the motor/generator MG is decelerated and transmitted to the output member O, as indicated by the straight line L3 in FIG. 14B.

Third Speed (3rd)

As shown in FIG. 13, at the third speed (3rd), only the second clutch C2 and the third clutch C3 are engaged. Then, as a result of engaging the second clutch C2, differential operation of the first planetary gear mechanism PG1 is limited, as indicated by the straight line L1 in FIG. 14C. In addition, as a result of engaging the third clutch C3, the rotation of the input member I is transmitted to the output member O without change.

On the other hand, as to the motor/generator MG, in the decelerating planetary gear unit P2 formed by both the second planetary gear mechanism PG2 and the third planetary gear mechanism PG3, because the ring gear r2 of the second planetary gear mechanism PG2 and the carrier ca3 of the third planetary gear mechanism PG3 are fixed, the rotation of the third rotation element s3, which is provided as an input from the motor/generator MG, is decelerated and transmitted to the carrier ca2 of the second planetary gear mechanism PG2 and to the ring gear r3 of the third planetary gear mechanism PG3, as indicated by the straight line L3 in FIG. 14C. Then, the transmitted rotation is output at that speed from the output member O.

Although the third speed is a shift speed at which the engine rotation is output without shifting, the rotation of the motor/generator MG is decelerated in the same manner as described so far.

Fourth Speed (4th)

As shown in FIG. 13, at the fourth speed (4th), only the third clutch C3 and the brake B1 are engaged. Then, in a state that the carrier ca1 of the first planetary gear mechanism PG1 is fixed by the brake B1, the rotation of the input member I is transmitted to the ring gear r1, and the rotation of the engine is accelerated and transmitted to the sun gear s1, as indicated by the straight line L1 in FIG. 14D. In this state, because the third clutch C3 is engaged, the rotation of the sun gear s1 is transmitted to the output member O.

On the other hand, as to the motor/generator MG, in the decelerating planetary gear unit P2 formed by both the second planetary gear mechanism PG2 and the third planetary gear mechanism PG3, because the ring gear r2 of the second planetary gear mechanism PG2 and the carrier ca3 of the third planetary gear mechanism PG3 are fixed, the rotation of the third rotation element s3, which is provided as an input from the motor/generator MG, is decelerated and transmitted to the carrier ca2 of the second planetary gear mechanism PG2 and to the ring gear r3 of the third planetary gear mechanism PG3, as indicated by the straight line L3 in FIG. 14D. Then, the transmitted rotation is output at that speed from the output member O.

Therefore, at this shift speed, there can be realized a so-called overdrive state in which the rotation speed of an engine E is accelerated and transmitted to the output member O.

### 7. Seventh Embodiment

Next, a seventh embodiment of the present invention will be described.

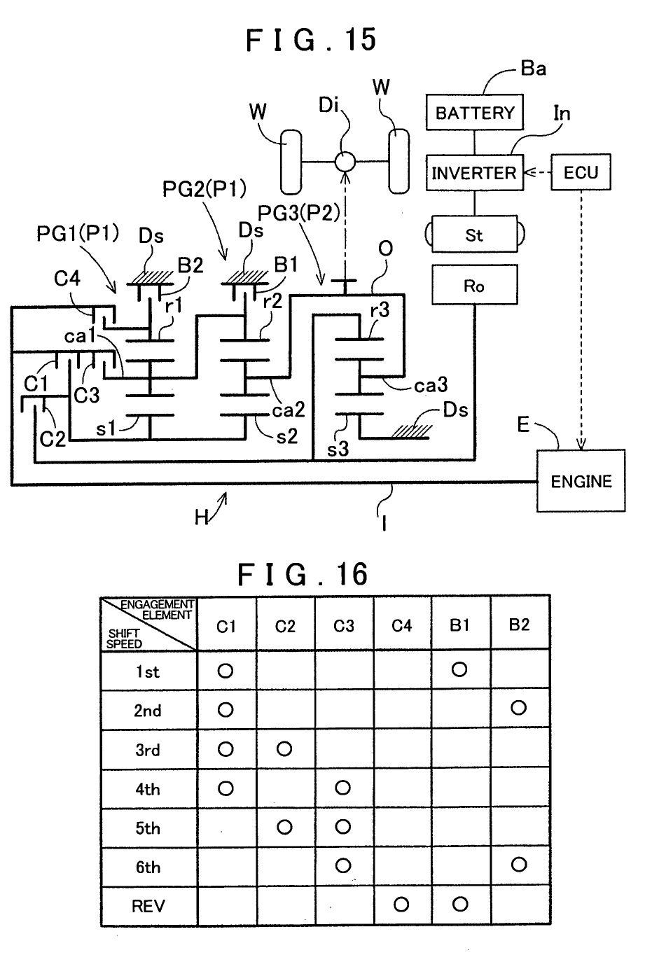

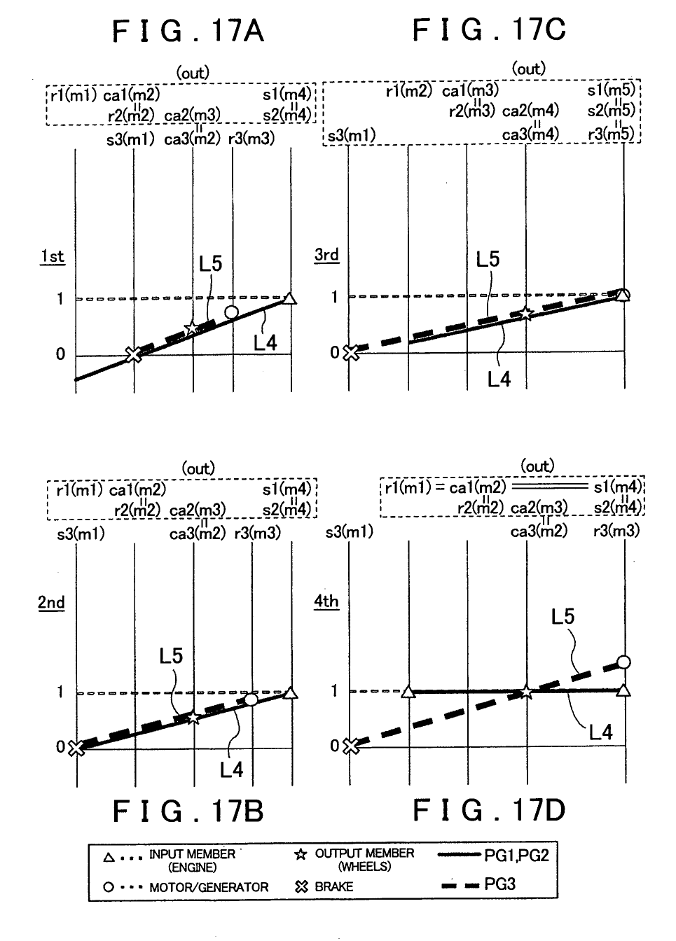

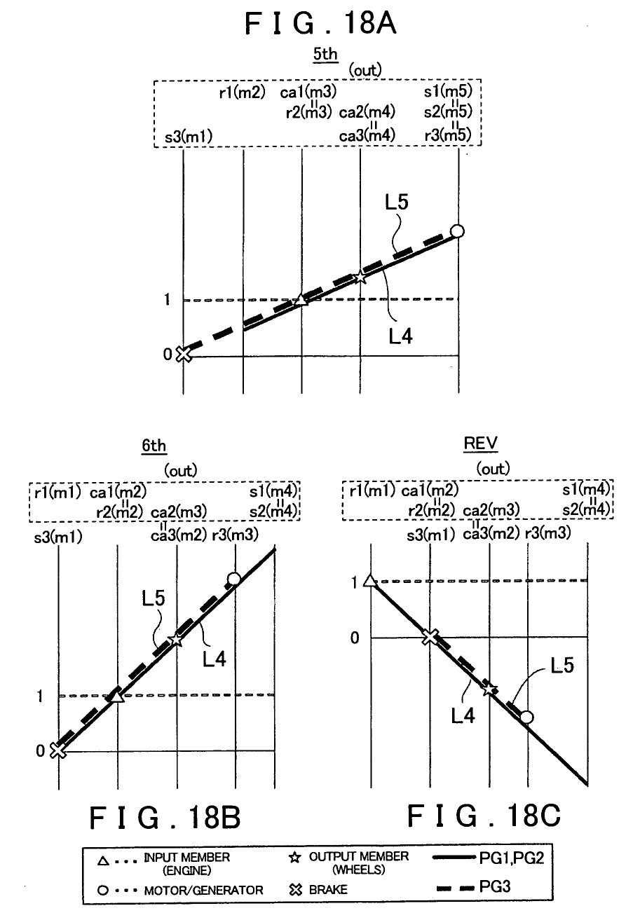

FIG. 15 is a skeleton diagram showing a structure of a hybrid drive unit H according to the present embodiment, FIG. 16 is an operation table of friction engagement elements included in the hybrid drive unit H according to the present embodiment, and each diagram in FIGS. 17A-18C is a velocity diagram at each shift speed.

In the present example, as shown in FIG. 15, a first planetary gear mechanism PG1 is a single-pinion type planetary gear mechanism that is arranged coaxially with an input member I.

A sun gear s1 is connected to a sun gear s2 of a second planetary gear mechanism PG2, and selectively connected to the input member I by a first clutch C1 serving as a first friction engagement element. The sun gear s1 is further selectively connected to a ring gear r3 of a third planetary gear mechanism PG3 and to a rotor Ro of a motor/generator MG by a second clutch C2 serving as a second friction engagement element. A carrier ca1 is connected to a ring gear r2 of the second planetary gear mechanism PG2, and selectively connected to a case Ds by a brake B1 serving as a fifth friction engagement element. The carrier ca1 is also selectively connected to the input member I by a third clutch C3 serving as a third friction engagement element. A ring gear r1 is selectively connected to the input member I by a fourth clutch C4 serving as a fourth friction engagement element, and also selectively connected to the case Ds by a second brake B2 serving as a sixth friction engagement element, to be stopped from rotating.

The second planetary gear mechanism PG2 is a single-pinion type planetary gear mechanism that is arranged coaxially with the input member I.

The sun gear s2 is connected to the sun gear s1 of the first planetary gear mechanism PG1, and selectively connected to the input member I by the first clutch C1 serving as the first friction engagement element. The sun gear s2 is further selectively connected to the ring gear r3 of the third planetary gear mechanism PG3 and to the rotor Ro of the motor/generator MG by the second clutch C2 serving as the second friction engagement element. A carrier ca2 is connected to an output member O and to a carrier ca3 of the third planetary gear mechanism PG3. The ring gear r2 is connected to the carrier ca1 of the first planetary gear mechanism PG1, and selectively connected to the input member I by the third clutch C3 serving as the third friction engagement element. The ring gear r2 is further selectively connected to the case Ds by the first brake B1 serving as the fifth friction engagement element, to be stopped from rotating.

As a result, both the first planetary gear mechanism PG1 and the second planetary gear mechanism PG2 mainly serve together as a shifting planetary gear unit P1 that changes the rotation speed of the input member I and transmits the rotation to the output member O.

The third planetary gear mechanism PG3 is a single-pinion type planetary gear mechanism that is arranged coaxially with the input member I.

A sun gear s3 is connected to the case Ds to be stopped from rotating. The carrier ca3 is connected to the output member O and to the carrier ca2 of the second planetary gear mechanism PG2. The ring gear r3 is connected to the rotor Ro of the motor/generator MG, and also is selectively connected to the sun gears s1 and s2 of the first planetary gear mechanism PG1 and the second planetary gear mechanism PG2, respectively, by the second clutch C2 serving as the second friction engagement element.

As a result, the third planetary gear mechanism PG3 mainly serves as a decelerating planetary gear unit P2 that always decelerates the rotation speed of the motor/generator MG and transmits the rotation to the output member O.

In the present example, the second clutch C2, which is the second friction engagement element, serves to unite the shifting planetary gear unit P1 with the decelerating planetary gear unit P2.

### Shift Speeds

In the above-described structure, each shift speed is realized as follows. First Speed (1st)

As shown in FIG. 16, at the first speed (1st), only the first clutch C1 and the first brake B1 are engaged. Then, as a result of engaging the first clutch C1, the rotation of the input member I is provided as an input to the sun gears s1 and s2 of the first planetary gear mechanism PG1 and the second planetary gear mechanism PG2. On the other hand, as a result of engaging the first brake B1, the carrier ca1 of the first planetary gear mechanism PG1 and the ring gear r2 of the second planetary gear mechanism PG2 are stopped from rotating. Therefore, as indicated by the straight line L4 in FIG. 17A, both the first planetary gear mechanism PG1 and the second planetary gear mechanism PG2, constituting a decelerating mechanism, decelerate the rotation of the sun gear s1 of the first planetary gear mechanism PG1 and the sun gear s2 of the second planetary gear mechanism PG2, and transmit the rotation to the carrier ca2 of the second planetary gear mechanism PG2, to provide the rotation as an output to the output member O.

On the other hand, the rotation of the motor/generator MG is provided as an input to the ring gear r3 of the third planetary gear mechanism PG3, then, as indicated by the straight line L5 in FIG. 17A, decelerated and transmitted to the output member O because the sun gear s3 is fixed.

Second Speed (2nd)

As shown in FIG. 16, at the second speed (2nd), only the first clutch C1 and the second brake B2 are engaged. Then, as a result of engaging the first clutch C1, the rotation of the input member I is provided as an input to the sun gears s1 and s2 of the first planetary gear mechanism PG1 and the second planetary gear mechanism PG2. On the other hand, as a result of engaging the second brake B2, the ring gear r1 of the first planetary gear mechanism PG1 is stopped from rotating. Therefore, as indicated by the straight line L4 in FIG. 17B, both the first planetary gear mechanism PG1 and the second planetary gear mechanism PG2, constituting a decelerating mechanism, decelerate the rotation of the sun gear s1 of the first planetary gear mechanism PG1, and transmit the rotation to the carrier ca2 of the second planetary gear mechanism PG2, to provide the rotation as an output to the output member O.

On the other hand, the rotation of the motor/generator MG is provided as an input to the ring gear r3 of the third planetary gear mechanism PG3, then, as indicated by the straight line L5 in FIG. 17B, decelerated and transmitted to the output member O because the sun gear s3 is fixed.

Third Speed (3rd)

As shown in FIG. 16, at the third speed (3rd), only the first clutch C1 and the second clutch C2 are engaged. Then, as a result of engaging the first clutch C1 and the second clutch C2, the rotation of the input member I is provided as an input to the sun gears s1 and s2 of the first planetary gear mechanism PG1 and the second planetary gear mechanism PG2, and to the ring gear r3 of the third planetary gear mechanism PG3. In this state, the rotation speeds of the motor/generator MG and the input member I are the same as each other.

In this state, the first planetary gear mechanism PG1, the second planetary gear mechanism PG2, and the third planetary gear mechanism PG3 constitute a decelerating mechanism serving as a unit.

As to this decelerating mechanism, because the sun gear s3 of the third planetary gear mechanism PG3 is fixed, both the rotation of the input member I and the rotation of the motor/generator MG are decelerated, and transmitted to the carriers ca2 and ca3 of the second planetary gear mechanism PG2 and the third planetary gear mechanism PG3, respectively, to be provided as an output to the output member O, as indicated by the overlapping straight lines L4 and L5 in FIG. 17C.

Fourth Speed (4th)

As shown in FIG. 16, at the fourth speed (4th), only the first clutch C1 and the third clutch C3 are engaged.

Then, as a result of engaging the first clutch C1 and the third clutch C3, differential operations of the first planetary gear mechanism PG1 and the second planetary gear mechanism PG2 are limited, as indicated by the straight line L4 in FIG. 17D. Therefore, the rotation of the input member I is transmitted to the output member O without change.

On the other hand, as to the motor/generator MG, because the sun gear s3 of the third planetary gear mechanism PG3 is fixed, the rotation of the motor/generator MG, which is transmitted to the ring gear r3, is decelerated and transmitted to the carrier ca3, then to the output member O, as indicated by the straight line L5 in FIG. 17D. Then, the rotation is output from the output member O.

Although the fourth speed is a shift speed at which the engine rotation is output without shifting, the rotation of the motor/generator MG is decelerated in the same manner as described so far.

Fifth Speed (5th)

As shown in FIG. 16, at the fifth speed (5th), only the second clutch C2 and the third clutch C3 are engaged. Then, as a result of engaging the second clutch C2, the first planetary gear mechanism PG1, the second planetary gear mechanism PG2, and the third planetary gear mechanism PG3 are united with each other.

In this united speed change mechanism, as indicated by the overlapping straight lines L4 and L5 in FIG. 18A, the sun gear s3 of the third planetary gear mechanism PG3 is fixed, and the rotation of the input member I is provided as an input to the carrier ca1 of the first planetary gear mechanism PG1 and to the ring gear r2 of the second planetary gear mechanism PG2. Then, in a state that the rotation of the motor/generator MG is provided as an input to the sun gears s1 and s2 of the first planetary gear mechanism PG1 and the second planetary gear mechanism PG2, and to the ring gear r3 of the third planetary gear mechanism PG3, each rotation is independently accelerated or decelerated, and then provided as accelerated or decelerated rotation output to the output member O, through output rotation elements, that is, the carrier ca2 of the second planetary gear mechanism PG2 and the carrier ca3 of the third planetary gear mechanism PG3.

Sixth Speed (6th)

As shown in FIG. 16, at the sixth speed (6th), only the third clutch C3 and the second brake B2 are engaged. In this state, the first planetary gear mechanism PG1 and the second planetary gear mechanism PG2 serve as the shifting planetary gear unit P1, and the third planetary gear mechanism PG3 serves as the decelerating planetary gear unit P2.

In the former shifting planetary gear unit P1, in a state that the ring gear r1 of the first planetary gear mechanism PG1 is fixed and that the rotation of the input member I is transmitted to the carrier ca1 of the first planetary gear mechanism PG1 and to the ring gear r2 of the second planetary gear mechanism PG2, the rotation of the input member I is accelerated and transmitted to the carrier ca2, which is an output rotation element, of the second planetary gear mechanism PG2, as indicated by the straight line L4 in FIG. 18B.

In the latter decelerating planetary gear unit P2, in a state that the sun gear s3 of the third planetary gear mechanism PG3 is fixed and that the rotation of the motor/generator MG is transmitted to the ring gear r3 of the third planetary gear mechanism PG3, the rotation of the motor/generator MG is decelerated and transmitted to the carrier ca3, which is an output rotation element, of the third planetary gear mechanism PG3, as indicated by the straight line L5 in FIG. 18B.

Then, the transmitted rotation is output from the output member O.

Therefore, at this shift speed, there can be realized a so-called overdrive state in which the rotation speed of an engine E is accelerated and transmitted to the output member O.

Reverse Speed (REV)

As shown in FIG. 16, at the reverse speed (REV), only the fourth clutch C4 and the first brake B1 are engaged. Then, as a result of engaging the fourth clutch C4, the rotation of the input member I is provided as an input to the ring gear r1 of the first planetary gear mechanism PG1. On the other hand, as a result of engaging the first brake B1, the ring gear r2 of the second planetary gear mechanism PG2 and the carrier ca1, which is connected to the ring gear r2, of the first planetary gear mechanism PG1 are stopped from rotating. In this state, by both the first planetary gear mechanism PG1 and the second planetary gear mechanism PG2, the rotation of the input member I is reversed and transmitted to the carrier ca2 of the second planetary gear mechanism PG2, to be provided as an output from the output member O, as indicated by the straight line L4 in FIG. 18C. On the other hand, as to the motor/generator MG, the sun gear s3 is fixed in the third planetary gear mechanism PG3, then the rotation (reverse rotation) of the motor/generator MG is provided as an input to the ring gear r3, and transmitted to the output member O at a decelerated speed, as indicated by the straight line L5 in FIG. 18C.

Therefore, at this shift speed, there can be realized a reverse state in which the rotation of the motor/generator MG is decelerated.

### 8. Other Embodiments

The embodiments explained above are merely examples of structures of the shifting planetary gear unit P1 and the decelerating planetary gear unit P2, and also merely examples of arrangement structures of the friction engagement elements for their rotation elements. Any structure, other than the above-described structures, that can realize a structure of the present invention is included in the scope of the present invention.

The present invention has made it possible to obtain a hybrid drive unit H that can employ, as its rotary electric machine MG, a comparatively small-sized rotary electric machine, and also that is excellent in ease of installation, without requiring high hydraulic pressure.

Note that in the present application “connection” not only includes a structure to perform a direct transmission of rotation, but also includes a structure to perform an indirect transmission of rotation through one or two or more members. In addition, in the present application, with respect to a planetary gear mechanism provided with three rotation elements of a sun gear, carrier, and ring gear, the single planetary gear mechanism or a device obtained by combining a plurality of planetary gear mechanisms is called “planetary gear unit.” Moreover, “rotary electric machine” is used as a concept that includes any one of a motor (electric rotating machine), a generator (electricity generating machine), and a motor/generator, which serves as both a motor and a generator as needed.

According to an exemplary aspect of the invention, the hybrid drive unit is provided with both the decelerating planetary gear unit and the shifting planetary gear unit. The decelerating planetary gear unit serves at least to decelerate the rotation of the rotary electric machine and output it to the output member side (to accelerate rotation and output it in the case of transmitting the rotation from the output member) at all of the shift speeds. On the other hand, the shifting planetary gear unit serves to output the rotation that is provided as an input from the input member, with or without shifting.

Because, in addition to serving to decelerate the rotation of the rotary electric machine and transmit the rotation to the output member side, this decelerating planetary gear unit includes at least one rotation element serving as a fixed rotation element whose rotation is fixed by a non-rotating member (for example, a transmission case), this rotation element contributes to the deceleration by the planetary gear unit. In other words, other elements such as hydraulic pressure are not required to realize the deceleration with the decelerating planetary gear unit. Moreover, because the rotation of the rotary electric machine is directly decelerated by the planetary gear unit and transmitted to the output member, the output power of the rotary electric machine can be used with less loss, and a comparatively small rotary electric machine can be employed. As a result, the problem of worsening the ease of installation can be mitigated.

On the other hand, because the input from the input member is transmitted to the output member with the input speed changed by the shifting planetary gear unit as appropriate, the input from the input member and also the output of the rotary electric machine can be used with their speeds favorably changed.

According to an exemplary aspect of the invention, the hybrid drive unit is provided with at least a shifting planetary gear unit and a decelerating planetary gear unit. Therefore, it is useful to have a structure that can realize the independent operation mode in which these planetary gear units operate independently, and the unit operation mode in which they operate as a unit, because a plurality of shift speeds can be realized using a minimum number of planetary gear units.

In addition, in the case of adopting this structure, a preferable multi-speed automatic transmission can be achieved by employing a structure that realizes a plurality of shift speeds in the unit operation mode.

Moreover, by employing a structure in which the shift speeds include an acceleration shift speed for accelerating an engine output and transmitting the engine output to the output member, even a driving condition such as a high-speed low-torque condition can be suitably supported.

Furthermore, in the hybrid drive unit so far described above, by providing the engine to be able to be disconnected from the rotary electric machine, driving only by the rotary electric machine can be performed without being affected by the engine side.

According to an exemplary aspect of the invention, it is preferable to employ a structure in which the rotary electric machine is arranged on the engine side with respect to the pair of planetary gear units. By employing this structure, it becomes possible to package the rotary electric machine, which occupies a relatively larger area than the transmission portion, on the engine side, and thus to provide a hybrid drive unit excellent in ease of installation. With this structure, for example, in a front-engine front-drive vehicle, it becomes possible to have a neat design in the front area.

In addition, by employing this structure, the rotary electric machine can be disposed in a position where a torque converter of an automatic transmission is conventionally arranged, ease of installation in a vehicle does not worsen.

According to an exemplary aspect of the invention, a direction of taking out output may be in any direction. For example, in the case of adopting a structure in which an engine output is provided as an input from the rear side (engine side) of the hybrid drive unit through an input shaft (a kind of input member), the output may be taken out in a radial direction of the unit, that is, in a direction perpendicular to the input shaft, or may be taken out from the front side of the hybrid drive unit, that is, from the side opposite the engine. The hybrid drive unit of the latter structure can preferably be applied to a vehicle having a front-engine rear-drive configuration.

Note that in the present application, the “order of rotation speed” is either the order from a high-speed side to a low-speed side or the order from a low-speed side to a high-speed side, and can be any of the orders depending on the state of rotation of each planetary gear unit; however, the order of the rotation elements does not change in either case.

According to an exemplary aspect of the invention, a planetary gear unit includes the first rotation element, the second rotation element, and the third rotation element, and by structuring the planetary gear unit such that the first rotation element is a fixed rotation element and the third rotation element is connected to a rotor of the rotary electric machine, the rotation of the rotor can be decelerated and transmitted to the second rotation element, and also the drive, when transmitted to the rotor side, is transmitted while being accelerated.

Then, such a deceleration structure can be realized with the simple planetary gear unit that includes the first rotation element, the second rotation element, and the third rotation element.

In addition, in the decelerating planetary gear unit so far described above, by employing a structure that includes a plurality of planetary gear mechanisms having at least three rotation elements, it becomes possible to provide multiple levels of deceleration at least on the rotary electric machine side, by combining the plurality of planetary gear mechanisms.

On the other hand, in the shifting planetary gear unit so far described above, by employing a structure that includes a plurality of planetary gear mechanisms having at least three rotation elements, it becomes possible to provide multiple shift speeds at least on the input member side, by combining the plurality of planetary gear mechanisms.

By employing a structure in which the above-described plurality of shift speeds include a reverse speed, not only forward speeds but also a reverse speed can be realized in the hybrid drive unit which is provided with a comparatively small rotary electric machine while being compact, and which can produce a comparatively large driving force even only with the rotary electric machine.

What is claimed is:

1. A hybrid drive unit comprising:
an input member connected to an engine;
an output member connected to wheels;
a rotary electric machine; and
a pair of planetary gear units that each have at least three rotation elements, wherein:
the hybrid drive unit is capable of realizing a plurality of shift speeds,
one planetary gear unit of the pair of planetary gear units comprises at least one fixed rotation element that serves as a rotation element whose rotation is stopped by a non-rotating member, the one planetary gear unit serving as a decelerating planetary gear unit that decelerates a rotation of the rotary electric machine and transmits a decelerated rotation to the output member at all of the shift speeds, and
the other planetary gear unit of the pair of planetary gear units serves as a shifting planetary gear unit that transmits a rotation of the input member to the output member.

2. The hybrid drive unit according to claim 1, wherein the hybrid drive unit is capable of realizing both an independent operation mode in which the pair of planetary gear units operate independently from each other, and a unit operation mode in which the pair of planetary gear units operate as a unit.

3. The hybrid drive unit according to claim 2, wherein the hybrid drive unit realizes a plurality of shift speeds in the unit operation mode.

4. The hybrid drive unit according to claim 3, wherein a shift speed of the plurality of shift speeds that are realized in the unit operation mode includes an acceleration shift speed at which an engine output is transmitted to the output member with an accelerated speed.

5. The hybrid drive unit according to claim 4, wherein the engine is capable of being disconnected from the rotary electric machine.

6. The hybrid drive unit according to claim 5, wherein the rotary electric machine is arranged on an engine side with respect to the pair of planetary gear units.

7. The hybrid drive unit according to claim 6, wherein:
the decelerating planetary gear unit comprises a first rotation element, a second rotation element, and a third rotation element;
the first rotation element of the decelerating planetary gear unit is a rotation element whose rotation is stopped by a non-rotating member;
the second rotation element of the decelerating planetary gear unit is connected to the output member; and
the third rotation element of the decelerating planetary gear unit is connected to the rotary electric machine.

8. The hybrid drive unit according to claim 7, wherein the decelerating planetary gear unit comprises a plurality of planetary gear mechanisms having at least three rotation elements.

9. The hybrid drive unit according to claim 8, wherein the shifting planetary gear unit comprises a plurality of planetary gear mechanisms having at least three rotation elements.

10. The hybrid drive unit according to claim 9, wherein a shift speed of the plurality of shift speeds that are realized in the unit operation mode includes a reverse speed.

11. The hybrid drive unit according to claim 1, wherein a shift speed of the plurality of shift speeds includes an acceleration shift speed at which an engine output is transmitted to the output member with an accelerated speed.

12. The hybrid drive unit according to claim 1, wherein the engine is capable of being disconnected from the rotary electric machine.

13. The hybrid drive unit according to claim 1, wherein the rotary electric machine is arranged on an engine side with respect to the pair of planetary gear units.

14. The hybrid drive unit according to claim 1, wherein:
the decelerating planetary gear unit comprises a first rotation element, a second rotation element, and a third rotation element;
the first rotation element of the decelerating planetary gear unit is a rotation element whose rotation is stopped by a non-rotating member;
the second rotation element of the decelerating planetary gear unit is connected to the output member; and
the third rotation element of the decelerating planetary gear unit is connected to the rotary electric machine.

15. The hybrid drive unit according to claim 1, wherein the decelerating planetary gear unit comprises a plurality of planetary gear mechanisms having at least three rotation elements.

16. The hybrid drive unit according to claim 1, wherein the shifting planetary gear unit comprises a plurality of planetary gear mechanisms having at least three rotation elements.

17. The hybrid drive unit according to claim 1, wherein an output of the output member is extended either to a front side of the hybrid drive unit or in a radial direction of the input member.

18. A hybrid drive unit comprising:
an input member connected to an engine;
an output member connected to wheels;
a single rotary electric machine;
a decelerating planetary gear unit; and
a shifting planetary gear unit, wherein:
the decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine, and
the shifting planetary gear unit comprises a first rotation element, a second rotation element, and a third rotation element, with the first rotation element of the shifting planetary gear unit being selectively connected to a non-rotating member and also being selectively connected to the input member, the second rotation element of the shifting planetary gear unit being connected to the second rotation element of the decelerating planetary gear unit and also being connected to the output member, and the third rotation element of the shifting planetary gear unit being selectively connected to the third rotation element of the decelerating planetary gear unit and also being selectively connected to the input member.

19. A hybrid drive unit comprising:
an input member connected to an engine;
an output member connected to wheels;
a single rotary electric machine;
a decelerating planetary gear unit; and
a shifting planetary gear unit, wherein:
the decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine, and
the shifting planetary gear unit comprises a first rotation element, a second rotation element, and a third rotation element, with the first rotation element of the shifting planetary gear unit being connected to the second rotation element of the decelerating planetary gear unit and also being connected to the output member, the second rotation element of the shifting planetary gear unit being selectively connected to the input member, and the third rotation element of the shifting planetary gear unit being selectively connected to the third rotation element of the decelerating planetary gear unit, the input member and to a non-rotating member.

20. A hybrid drive unit comprising:
an input member connected to an engine;
an output member connected to wheels;
a single rotary electric machine;
a decelerating planetary gear unit; and
a shifting planetary gear unit, wherein:
the decelerating planetary gear unit comprises a first rotation element, a second rotation element, and a third rotation element, with the first rotation element of the decelerating planetary gear unit serving as a rotation element whose rotation is stopped by a non-rotating member, the second rotation element of the decelerating planetary gear unit being connected to the output member, and the third rotation element of the decelerating planetary gear unit being connected to the rotary electric machine, and
the shifting planetary gear unit comprises a first rotation element, a second rotation element, and a third rotation element, with the first rotation element of the shifting planetary gear unit being selectively connected to the second rotation element of the decelerating planetary gear unit and being selectively connected to the input member, the second rotation element of the shifting planetary gear unit being connected to the input member, and the third rotation element of the shifting planetary gear unit being selectively connected to the third rotation element of the decelerating planetary gear unit and being selectively connected to a non-rotating member.
